(19) United States
(12) Patent Application Publication
(10) Pub. No.: US 2015/0201644 A1
(43) Pub. Date: Jul. 23, 2015

(54) CHEWING GUM COMPOSITIONS AND METHODS OF MAKING THEREOF

(71) Applicant: INTERCONTINENTAL GREAT BRANDS LLC, EAST HANOVER, NJ (US)

(72) Inventors: Kishor Kabse, Whippany, NJ (US); Leonard Scarola, Whippany, NJ (US)

(73) Assignee: INTERCONTINENTAL GREAT BRANDS LLC, East Hanover, NJ (US)

(21) Appl. No.: 14/421,077

(22) PCT Filed: Jun. 7, 2013
(86) PCT No.: PCT/US2013/044642

§ 371 Date: Feb. 11, 2015

Related U.S. Application Data
(60) Provisional application No. 61/691,840, filed on Aug. 22, 2012.

(51) Int. Cl. A23G 4/10; A23G 4/20

(52) U.S. Cl. CPC A23G 4/10; A23G 4/205; A23G 4/20; A23V 2002/00

(57) ABSTRACT

Chewing gum compositions comprising a chewy cooked candy ingredient exhibit improved flavor release.

### FIELD

This disclosure generally relates to chewing gum, more particularly to chewing gum containing a cooked candy ingredient.

### BACKGROUND

A well-known problem in the chewing gum art is the elastomeric portions of the chewing gum base engages flavors, sensates and other additives of a hydrophobic nature and retards their release, particularly in the early stages of the chew process. The result is a lower flavor experience by the consumer.

There remains a need in the art for providing chewing gum which provides sufficient release of flavor, sweeteners, and other ingredients during the first few bites of the chewing process. There also remains a need in the art for chewing gum exhibiting a large release of flavor early in the chewing process.

### SUMMARY

In an embodiment, a chewing gum product comprises a chewing gum composition comprising a gum base; and a chewy cooked candy comprising i) a cooked saccharide, a cooked sugar alcohol, or a combination thereof, ii) a flavorant, iii) an emulsifier, iv) a fat, v) a hydrocolloid, and optionally vi) a fondant, a food acid or salt thereof, a high intensity sweetener, a sensate, or a combination thereof; wherein the chewy cooked candy comprises about 5 to about 15 wt % moisture based on the total weight of the chewy cooked candy; wherein the chewing gum composition and chewy cooked candy form a homogeneous mixture.

In an embodiment, a chewing gum product comprises a chewing gum composition comprising a gum base; and a chewy cooked candy comprising i) a cooked saccharide, a cooked sugar alcohol, or a combination thereof, ii) a flavorant, iii) an emulsifier, iv) a fat, v) a hydrocolloid, and optionally vi) a fondant, a food acid or salt thereof, a high intensity sweetener, a sensate, or a combination thereof; wherein the chewy cooked candy comprises about 5 to about 15 wt % moisture based on the total weight of the chewy cooked candy; wherein the chewing gum composition and chewy cooked candy form a homogeneous mixture; and wherein when measured at a time period of up to 15 minutes of chewing, the chewing gum product releases more flavor than a comparative chewing gum having identical type and amount of ingredients, wherein the ingredients i)-vi) are not prepared as a candy or a pre-blend of ingredients prior to combining with the chewing gum composition

In an embodiment, a method of making a chewing gum product comprises mixing gum base or a combination of gum base and a chewing gum ingredient to form an intermediate chewing gum composition; and mixing the intermediate chewing gum composition with a chewy cooked candy to form a chewing gum product, wherein the chewy cooked candy comprises i) a saccharide, a sugar alcohol, or a combination thereof, ii) a flavorant, iii) an emulsifier, iv) a fat, v) a hydrocolloid, and optionally vi) a fondant, a food acid or salt thereof, a high intensity sweetener, a sensate, or a combination thereof.

The above described and other features are exemplified by the following detailed description.

### BRIEF DESCRIPTION OF THE DRAWINGS

FIG. 1 is a graphical representation of methyl salicylate release in milligrams versus time using a mechanical chew extraction method from chewing gums containing the same ingredients, with (Ex. 1) and without (CE) a chewy cooked candy ingredient.

### DETAILED DESCRIPTION

Disclosed herein are chewing gum products that comprise a chewy cooked candy ingredient and a chewing gum composition comprising gum base, wherein the chewy cooked candy and the chewing gum composition comprising gum base have been combined to form a homogeneous blend. The chewy cooked candy comprises a sweetener and a flavorant, and optionally an emulsifier, a fat, a fondant, a food acid or salt thereof, a high intensity sweetener, a sensate, a hydrocolloid, a flavor modulator or potentiator, a coloring agent, a functional ingredient, a humectant, or a combination thereof. The chewing gum composition may comprise a bulk sweetener, or an additional ingredient such as a flavorant, a food acid or salt thereof, a high intensity sweetener, a sensate, a flavor modulator or potentiator, a coloring agent, a functional ingredient, a humectant, a hydrocolloid, or a combination thereof, these ingredients being distinct from the ingredients provided by the chewy cooked candy ingredient.

Use of the chewy cooked candy in a chewing gum product provides a chewing gum with good early release of flavor. Not wishing to be bound by theory, but it is theorized that the use of the chewy cooked candy prevents flavorants, sensates, etc., particularly of a hydrophobic nature, present in the hydrophilic chewy cooked candy from getting trapped in the hydrophobic gum base, allowing these ingredients to be released from the chewing gum product quicker and more completely. Also, the chewy cooked candy chews out quickly because it is in a large proportion an amorphous mass, having a viscosity and structure that holds flavor which is released as the cooked candy dissolves in saliva during the chewing process. The faster release of chewy cooked candy ingredients provides a quick burst of flavor such that the consumer experiences a more intense, up-front flavor, juicier perception (such as when food acid is used) and quicker sweetness profile (such as when high intensity sweetener is used) early in the chew process.

### Chewy Cooked Candy

The chewing gum product comprises a chewy cooked candy as an ingredient which imparts various desirable attributes to the chewing gum product including improved flavor perception (inclusive of aroma, taste, and mouth feel) particularly at the earlier chew bites. The cooked candy is a chewy cooked candy prepared by a cooking process, i.e. where water, used to dissolve crystalline solids, in the initial candy ingredient mixture is removed with heat and/or vacuum, or where the candy ingredients are heated above a temperature of 90° C. The cooked candy can be fully amorphous, predominantly amorphous (e.g. partially grained), but not fully grained.

The chewy cooked candy ingredient can have a moisture content of about 5 to about 15 weight percent (wt %), specifically about 6 to about 12 wt %, and yet more specifically about 7 to about 10 wt % based on the total weight of the cooked candy,

In an embodiment, the chewing gum product comprises two or more cooked candies, for a multiplicity of flavor release.

The chewy cooked candy can be prepared from a sweetener including a saccharide, a sugar alcohol, or a combination thereof, either in syrup or solid particulate or powder form, crystalline or amorphous. Sugar alcohol is also referred to herein as “sugar polyol”.

Suitable saccharides for use to prepare the chewy cooked candy include mono-saccharide, di-saccharide and poly-saccharide solids or syrups of sucrose (sugar), dextrose, maltose, dextrin, xylose, ribose, glucose, mannose, galactose, fructose (levulose), lactose, invert sugar, fructo oligo saccharide, partially hydrolyzed starch, high fructose corn syrup, polydextroses, corn syrup solids, or a combination thereof.

Suitable sugar alcohols for use to prepare the chewy cooked candy include solids (particulate) or syrups of erythritol, galactitol, hydrogenated starch hydrolysate, isomaltulose, isomalt, lactitol, maltitol, mannitol, polyglucitol, sorbitol, xylitol, or a combination thereof. In an embodiment, the chewy cooked candy is made from a sugar alcohol syrup such as a hydrogenated starch hydrolysate syrup, a maltitol syrup, a sorbitol syrup, or a combination thereof. The sugar alcohol syrup can be a non-crystallizing syrup.

The isomalt includes 6-O-α-D-glucopyranosyl-D-sorbitol (1,6-GPS); 1-O-α-D-glucopyranosyl-D-sorbitol (1,1-GPS); 1-O-α-D-glucopyranosyl-D-mannitol (1,1-GPM); 6-O-α-D-glucopyranosyl-D-mannitol (1,6-GPM); or a combination thereof. Some commercially available isomalt materials include an almost equimolar mixture of 1,6-GPS, and 1,1-GPM. Other isomalt materials can include pure 1,6-GPS; 1,1-GPS; 1,6-GPM; and 1,1-GPM. Still other isomalt materials can include mixtures of 1,6-GPS; 1,1-GPS; 1,6-GPM; and 1,1-GPM at any ratio.

The amount of sweetener comprising a saccharide, a sugar alcohol, or a combination thereof present in the chewy cooked candy is about 30 to about 95 wt % based on the total weight of the chewy cooked candy, specifically about 40 to about 85 wt %, more specifically about 45 to about 75 wt %, and yet more specifically about 50 to about 65 wt %.

In an embodiment, the chewy cooked candy comprises i) a cooked saccharide, a cooked sugar alcohol, or a combination thereof, ii) a flavorant, and optionally iii) a fondant, a fat, an emulsifier, a hydrocolloid, a food acid or salt thereof, a high intensity sweetener, a sensate, or a combination thereof.

In an embodiment, the chewy cooked candy comprises i) a cooked saccharide, a cooked sugar alcohol, or a combination thereof, ii) a flavorant, iii) a fat, and optionally iv) a fondant, an emulsifier, a hydrocolloid, a food acid or salt thereof, a high intensity sweetener, a sensate, or a combination thereof.

In an embodiment, the chewy cooked candy comprises i) a cooked saccharide, a cooked sugar alcohol, or a combination thereof, ii) a flavorant, iii) a fat, iv) an emulsifier, and optionally v) a fondant, a hydrocolloid, a food acid or salt thereof, a high intensity sweetener, a sensate, or a combination thereof.

In an embodiment, the chewy cooked candy comprises i) a cooked saccharide, a cooked sugar alcohol, or a combination thereof, ii) a flavorant, iii) a fat, iv) an emulsifier, v) a hydrocolloid, and optionally vi) a fondant, a food acid or salt thereof, a high intensity sweetener, a sensate, or a combination thereof.

In an embodiment, the chewy cooked candy comprises i) a cooked saccharide, a cooked sugar alcohol, or a combination thereof, ii) a flavorant, iii) a hydrocolloid, and optionally iv) a fondant, a fat, an emulsifier, a food acid or salt thereof, a high intensity sweetener, a sensate, or a combination thereof.

The chewy cooked candy used to prepare the chewing gum can comprise a flavorant. Exemplary flavorants (flavor, flavoring agent) that can be used include those artificial or natural flavors known in the art, for example synthetic flavor oils, natural flavoring aromatics and/or oils, oleoresins, extracts derived from plants, leaves, flowers, fruits, and the like, or a combination thereof. Non-limiting representative flavors include oils such as spearmint oil, cinnamon oil, oil of wintergreen (methyl salicylate), peppermint oil, clove oil, bay oil, anise oil, eucalyptus oil, thyme oil, cedar leaf oil, oil of nutmeg, allspice, oil of sage, mace, oil of bitter almonds, cassia oil, and citrus oils including lemon, orange, lime, grapefruit, vanilla, fruit essences, including apple, pear, peach, grape, strawberry, raspberry, blackberry, cherry, plum, pineapple, apricot, banana, melon, tropical fruit, mango, mangosteen, pomegranate, papaya, honey lemon, and the like, or a combination thereof. Specific flavorants are mints such as peppermint, spearmint, artificial vanilla, cinnamon derivatives, and various fruit flavors.

Other types of flavorants include various aldehydes and esters such as cinnamyl acetate, cinnamaldehyde, citral diethylacetal, dihydrocarvyl acetate, eugenyl formate, p-methylamisol, acetaldehyde (apple), benzaldehyde (cherry, almond), anisic aldehyde (licorice, anise), cinnamic aldehyde (cinnamon), citral, i.e., alpha-citral (lemon, lime), neral, i.e., beta-citral (lemon, lime), decanal (orange, lemon), ethyl vanillin (vanilla, cream), heliotrope, i.e., piperonal (vanilla, cream), vanillin (vanilla, cream), alpha-amyl cinnamaldehyde (spicy fruity flavors), butyraldehyde (butter, cheese), valeraldehyde (butter, cheese), citronellal (modifies, many types), decanal (citrus fruits), aldehyde C-8 (citrus fruits), aldehyde C-9 (citrus fruits), aldehyde C-12 (citrus fruits), 2-ethyl butyraldehyde (berry fruits), hexenal, i.e., trans-2 (berry fruits), tolyl aldehyde (cherry, almond), veratraldehyde (vanilla), 2,6-dimethyl-5-heptenal, i.e., melonal (melon), 2,6-dimethyloctanal (green fruit), and 2-dodecenal (citrus, mandarin).

The flavorant of the chewy cooked candy can be in liquid or solid form.

More than one flavorant can be used in the chewy cooked candy. The amount and type of flavorant used in the cooked candy can be chosen based on the targeted release profile and flavor intensity desired. The cooked candy generally comprises a flavorant in an amount of about 0.01 to about 20 wt % based on the total weight of the cooked candy, specifically about 0.1 to about 15 wt %, and yet more specifically about 1.0 to about 12 wt %, still yet more specifically about 1.5 to about 8wt %, more specifically about 2.0 to about 5 wt %, more specifically about 3.0 to about 4.5 wt %, and even more specifically about 3.5 to about 4 wt %.

Exemplary fats for use in the chewy cooked candy include fats and oils of vegetable origin, animal origin, or a combination thereof. Suitable vegetable fats can include soybean, cottonseed, corn, almond, peanut, sunflower, rapeseed, olive, palm, palm kernel, illipe, shea, coconut, cocoa, cocoa butter, or a combination thereof. The forgoing vegetable fats can be hydrogenated to varying degrees as desired or separated by fractional crystallization. Suitable animal fats include dairy fats such as milk fat and butter. As used herein, the term “fat” refers to any lipid material and can be solid or liquid (e.g. oil). Exemplary lipid materials include triglycerides, fatty alcohols, fatty acids, or a combination thereof. The triglyceride is not limited although medium chain triglycerides, long chain triglycerides, and the like can be used. The melting point of the fat is not limited although fats having a melting point of about 36 to about 68° C. can be used. Specific fats include hydrogenated palm oil, hydrogenated palm kernel oil, hydrogenated soybean oil, hydrogenated peanut oil, hydrogenated cottonseed oil, hydrogenated coconut oil, or a combination thereof.

When present in the chewy cooked candy, the fat can be in an amount of about 1.0 to about 10 wt % based on the total weight of the cooked candy, specifically about 2.5 to about 8.0, more specifically about 4.0 to about 7.0 wt %, and yet more specifically about 5.0 to about 6.0 wt %.

The chewy cooked candy can optionally contain an emulsifier. Exemplary emulsifiers include distilled monoglycerides, lecithin, acetic acid esters of mono and diglycerides, citric acid esters of mono and diglycerides, lactic acid esters of mono and diglycerides, mono and diglycerides, polyglycerol esters of fatty acids, ceteareth-20, polyglycerol polyricinoleate, propylene glycol esters of fatty acids, polyglyceryl laurate, glyceryl cocoate, gum arabic, acacia gum, sorbitan monostearates, sorbitan tristearates, sorbitan monolaurate, sorbitan monooleate, sodium stearoyl lactylates, calcium stearoyl lactylates, diacetyl tartaric acid esters of mono- and diglycerides, glyceryl tricaprylate-caprate/medium chain triglycerides, glyceryl dioleate, glyceryl oleate, glyceryl lacto esters of fatty acids, glyceryl lacto palmitate, glyceryl stearate (glyceryl monostearate), glyceryl laurate, glycerly dilaurate, glyceryl monoricinoleate, triglyceryl monostearate, hexaglyceryl distearate, decaglyceryl monostearate, decaglyceryl dipalmitate, decaglyceryl monooleate, polyglyceryl 10 hexaoleate, medium chain triglycerides, caprylic/capric triglyceride, propylene glycol monostearate, polysorbate 20, polysorbate 40, polysorbate 60, polysorbate 80, polysorbate 65, hexylglyceryl distearate, triglyceryl monostearate, tweens, spans, stearoyl lactylates, calcium stearoyl-2-lactylate, sodium stearoyl-2-lactylate lecithin, ammonium phosphatide, sucrose esters of fatty acids, sucroglycerides, propane-1,2-diol esters of fatty acids, or a combination thereof.

In an embodiment, the emulsifier of the chewy cooked candy is lecithin.

The emulsifier can be present in the chewy cooked candy in an amount of about 0.01 to about 15 wt % based on the total weight of the cooked candy, specifically about 0.1 to about 7.0 wt %, more specifically about 1.0 to about 5.0 wt %, and yet more specifically about 2.0 to about 3.5 wt %.

The chewy cooked candy may optionally further comprise a hydrocolloid. Hydrocolloid materials can include naturally occurring materials such as plant exudates, seed gums, and seaweed extracts or they can be chemically modified materials such as cellulose, starch, or natural gum derivatives. Furthermore, hydrocolloid materials can include pectin, gum arabic, acacia gum, alginates, agar, carageenans, guar gum, xanthan gum, locust bean gum, gelatin, gellan gum, galactomannans, tragacanth gum, karaya gum, curdlan, konjac, chitosan, xyloglucan, beta glucan, furcellaran, gum ghatti, tamarin, and bacterial gums. Modified natural gums include propylene glycol alginate, carboxymethyl locust bean gum, low methoxyl pectin, or a combination thereof. Modified celluloses can be included such as microcrystalline cellulose, carboxymethlcellulose (CMC), methylcellulose (MC), hydroxypropylmethylcellulose (HPCM), hydroxypropylcellulose (MPC), or a combination thereof. In an embodiment, the hydrocolloid is gelatin.

The chewy cooked candy can contain the hydrocolloid in an amount of about 0.01 to about 10 wt % based on the total weight of the cooked candy, specifically about 0.1 to about 7 wt %, more specifically about 1 to about 4 wt %, and still yet more specifically about 1.5 to about 2 wt %.

The chewy cooked candy may optionally further comprise a humectant. Exemplary humectants include glycerin, propylene glycol, polyethylene glycol, or a combination thereof. The humectant can be added to retard the loss of moisture and to retard crystallization of the sweetener.

The humectant can be present in an amount of about of about 0.1 to about 30 wt % based on the total weight of the cooked candy, specifically about 2.5 to about 20 wt %, more specifically about 4.0 to about 15 wt %, yet more specifically about 5.0 to about 10 wt %, and still yet more specifically about 6.0 to about 9.0 wt %.

The chewy cooked candy may comprise a food acid or salt thereof. Exemplary food acids and food acid salts for use in the flavor pre-blend include acetic acid, adipic acid, ascorbic acid, butyric acid, citric acid, formic acid, fumaric acid, glyconic acid, lactic acid, phosphoric acid, malic acid, oxalic acid, succinic acid, tartaric acid, and alkali metal salts thereof (e.g., sodium citrate dihydrate), or a combination thereof. In an embodiment, the food acid is citric acid, malic acid, tartaric acid or a combination thereof.

The chewy cooked candy may comprise a sensate. Exemplary sensates include cooling agents, warming agents, tingling agents, effervescent agents, or a combination thereof. Coolants are additives that provide a cooling or refreshing effect in the mouth, in the nasal cavity, or on skin. For example, among the useful cooling agents are included menthane, menthone, ketals, menthone ketals, menthone glycerol ketals, substituted p-menthanes, acyclic carboxamides, mono menthyl glutarate, substituted cyclohexanamides, substituted cyclohexane carboxamides, substituted ureas and sulfonamides, substituted menthanols, hydroxymethyl and hydroxymethyl derivatives of p-menthane, 2-mercapto-cyclo-decanone, hydroxycarboxylic acids with 2-6 carbon atoms, cyclohexanamides, menthyl acetate, menthyl salicylate, N,2,3-trimethyl-2-isopropyl butanamide (WS-23), N-ethyl-2,2-diisopropylbutanamide, N-ethyl-p-menthane-3-carboxamide (WS-3), ethyl ester of N-[[5-methyl-2-(1-methylethyl)cyclohexyl]carbonyl]glycine (WS-5), as well as the substantially pure ethyl ester of N-[[5-methyl-2-(1-methylethyl)cyclohexyl]carbonyl]glycine as disclosed in U.S. Pat. No. 7,189,760 to Erman, et al which is incorporated in its entirety herein by reference, isopulegol, menthyloxy propane diol, 3-(1-menthoxy)propane-1,2-diol, 3-(1-menthoxy)-2-methylpropane-1,2-diol, p-menthane-2,3-diol, p-menthane-3,8-diol, 6-isopropyl-9-methyl-1,4-dioxaspiro[4,5]decane-2-methanol, menthyl succinate and its alkaline earth metal salts, trimethylcyclohexanol, N-ethyl-2-isopropyl-5-methylcyclohexanecarboxamide, N-(4-cyanomethylphenyl) p-menthanecarboxamide (G-180), Japanese mint oil, peppermint oil, 3-(1-menthoxy)ethan-1-ol, 3-(1-menthoxy)propan-1-ol, 3-(1-menthoxy)butan-1-ol, 1-menthylacetic acid N-ethylamide, 1-menthyl-4-hydroxypentanoate, 1-menthyl-3-hydroxybutyrate, N,2,3-trimethyl-2-(1-methylethyl)-butanamide, n-ethyl-t-2-c-6 nonadienamide, N,N-dimethyl menthyl succinamide, substituted p-menthanes, substituted p-menthane-carboxamides, 2-isopropanyl-5-methylcyclohexanol (from Hisamitsu Pharmaceuticals, hereinafter “isopregol”); menthone glycerol ketals (FEMA 3807, tradename FRESCOLAT® type MGA); 3-1-menthoxypropane-1,2-diol (from Takasago, FEMA 3784); and menthyl lactate; (from Haarman & Reimer, FEMA 3748, tradename FRESCOLAT® type ML), WS-30, WS-14, Eucalyptus extract (p-Mehtha-3,8-Diol), Menthol (its natural or synthetic derivatives), Menthol PG carbonate, Menthol EG carbonate, Menthol glyceryl ether, N-tertbutyl-p-menthane-3-carboxamide, P-menthane-3-carboxylic acid glycerol ester, Methyl-2-isopryl-bicyclo (2.2.1), Heptane-2-carboxamide; Menthol methyl ether, menthyl pyrrolidone carboxylate; 2,5-dimethyl-4-(1-pyrrolidinyl)-3(2H)-furanone; cyclic α-keto enamines, cyclotene derivatives such as cyclopentenes including 3-methyl-2-(1-pyrrolidinyl)-2-cyclopenten-1-one and 5-methyl-2-(1-pyrrolidinyl)-2-cyclopenten-1-one, compounds of the formula:

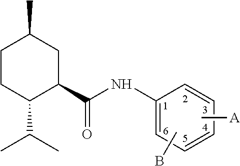

wherein B is selected from H, CH₃, C₂H₅, OCH₃, OC₂H₅; and OH; and wherein A is a moiety of the formula-CO-D, wherein D is selected from the following moieties: (i)-NR¹R², wherein R¹ and R² are independently selected from H and C₁-C₈ straight or branched-chain aliphatic, alkoxyalkyl, hydroxyalkyl, araliphatic and cycloalkyl groups, or R¹ and R² together with the nitrogen atom to which they are attached form part of an optionally-substituted, five-or six-membered heterocyclic ring; (ii)-NHCH₂COOCH₂CH₃,—NHCH₂CONH₂,—NHCH₂CH₂OCH₃,—NHCH₂CH₂OH,—NHCH₂CH(OH)CH₂OH and (iii) a moiety such as:

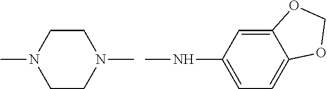

as disclosed in PCT Patent Application WO2006/125334 to Bell et al. which is incorporated in its entirety herein by reference, among others; or a combination thereof. Other compounds include the alpha-keto enamines disclosed in U.S. Pat. No. 6,592,884 to Hofmann et al. which is incorporated in its entirety herein by reference. These and other suitable cooling agents are further described in the following U.S. patents, all of which are incorporated in their entirety by reference hereto: U.S. Pat. Nos. 4,230,688; 4,032,661; 4,459,425; 4,178,459; 4,296,255; 4,136,163; 5,009,893; 5,266,592; 5,698,181; 6,277,385; 6,627,233; 7,030,273. Still other suitable cooling agents are further described in the following U.S. Published Patent Applications, all of which are incorporated in their entirety by reference hereto: U.S. 2005/0222256; 2005/0265930.

Warming agents can be selected from a wide variety of compounds known to provide the sensory signal of warming to the user. These compounds offer the perceived sensation of warmth, particularly in the oral cavity, and often enhance the perception of flavors, sweeteners and other organoleptic components. Among the useful warming agents included are vanillyl alcohol n-butylether (TK-1000) supplied by Takasago Perfumary Company Limited, Tokyo, Japan, vanillyl alcohol n-propylether, vanillyl alcohol isopropylether, vanillyl alcohol isobutylether, vanillyl alcohol n-aminoether, vanillyl alcohol isoamylether, vanillyl alcohol n-hexylether, vanillyl alcohol methylether, vanillyl alcohol ethylether, gingerol, shogaol, paradol, zingerone, capsaicin, dihydrocapsaicin, nordihydrocapsaicin, homocapsaicin, homodihydrocapsaicin, ethanol, isopropol alcohol, iso-amylalcohol, benzyl alcohol, glycerine, or a combination thereof.

In an embodiment, tingling agents may be employed to provide a tingling, stinging or numbing sensation to the user. Tingling agents include, but are not limited to: Jambu Oleoresin or para cress (Spilanthes sp.), in which the active ingredient is Spilanthol; Japanese pepper extract (Zanthoxylum peperitum), including the ingredients known as Saanshool-I, Saanshool-II and Sanshoamide; perillartine; 4-(1-menthoxymethyl)-2-phenyl-1,3-dioxolane; black pepper extract (piper nigrum), including the active ingredients chavicine and piperine; Echinacea extract; Northern Prickly Ash extract; trans-pellitorin, and red pepper oleoresin; or a combination thereof. In an embodiment, alkylamides extracted from materials such as jambu or sanshool may be included. Additionally, in an embodiment, a sensation is created due to effervescence. Such effervescence is created by combining an alkaline material with an acidic material, either or both of which may be encapsulated. In an embodiment, an alkaline material may include alkali metal carbonates, alkali metal bicarbonates, alkaline earth metal carbonates, alkaline earth metal bicarbonates or a combination thereof. In an embodiment, an acidic material may include acetic acid, adipic acid, ascorbic acid, butyric acid, citric acid, formic acid, fumaric acid, glyconic acid, lactic acid, phosphoric acid, malic acid, oxalic acid, succinic acid, tartaric acid or a combination thereof. Examples of “tingling” type sensates include those disclosed in U.S. Pat. Nos. 6,780,443, 6,159,509, 5,545,424, and 5,407,665, each of which is incorporated by reference herein in its entirety.

A sweet taste can come from flavor modulators or potentiators and/or from flavorants as well as from sweeteners. Flavor potentiators can consist of materials that intensify, supplement, modify or enhance the taste or aroma perception of an original material without introducing a characteristic taste or aroma perception of their own. Flavor modulators can impart a characteristic of their own that complements or negates a characteristic of another component. In an embodiment, flavor modulators or potentiators are designed to intensify, supplement, modify, or enhance the perception of flavor, sweetness, tartness, umami, kokumi, saltiness or a combination thereof can be included. Thus, the addition of flavor modulators or potentiators can impact the overall taste of the chewing gum. For example, flavors can be compounded to have additional sweet notes by the inclusion of flavor modulators or potentiators, such as vanilla, vanillin, ethyl maltol, furfual, ethyl propionate, lactones, or a combination thereof.

Exemplary flavor modulators or potentiators include monoammonium glycyrrhizinate, licorice glycyrrhizinates, citrus aurantium, alapyridaine, alapyridaine (N-(1-carboxyethyl)-6-(hydroxymethyl)pyridinium-3-ol) inner salt, miraculin, curculin, strogin, mabinlin, gymnemic acid, cynarin, glupyridaine, pyridinium-betain compounds, neotame, thaumatin, neohesperidin dihydrochalcone, tagatose, trehalose, maltol, ethyl maltol, vanilla extract, vanilla oleoresin, vanillin, sugar beet extract (alcoholic extract), sugarcane leaf essence (alcoholic extract), compounds that respond to G-protein coupled receptors (T2Rs and T1Rs), or a combination thereof. In an embodiment, sugar acids, sodium chloride, potassium chloride, sodium acid sulfate, or a combination thereof are used. In an embodiment, glutamates such as monosodium glutamate, monopotassium glutamate, hydrolyzed vegetable protein, hydrolyzed animal protein, yeast extract, or a combination thereof are included. Further examples include adenosine monophosphate (AMP), glutathione, and nucleotides such as inosine monophosphate, disodium inosinate, xanthosine monophosphate, guanylate monophosphate, or a combination thereof. Further examples of flavor potentiator compositions that impart kokumi are also included in U.S. Pat. No. 5,679,397 to Kuroda et al.

The amount of flavor modulators, flavor potentiators, and flavorants used herein can be a matter of preference subject to such factors as the type of final product composition, the individual flavor, and the strength of flavor desired. Thus, the amount of flavoring can be varied in order to obtain the result desired in the final product and such variations are within the capabilities of those skilled in the art without the need for undue experimentation.

Exemplary functional ingredients for use in the cooked candy include a breath freshener, a dental care component, an active, an herbal, an effervescing system, an appetite suppressor, a vitamin, a micronutrient, a mouth moistening component, a throat care component, an energy boosting agent, a concentration boosting agent, or a combination thereof.

The chewy cooked candy may comprise a high intensity sweetener. A “high intensity sweetener” as used herein means agents having a sweetness greater than the sweetness of sucrose. In an embodiment, a high intensity sweetener has a sweetness that is at least 100 times that of sugar (sucrose) on a per weight basis, specifically at least 500 times that of sugar on a per weight basis. In an embodiment the high intensity sweetener is at least 1,000 times that of sugar on a per weight basis, more specifically at least 5,000 times that of sugar on a per weight basis. The high intensity sweetener can be selected from a wide range of materials, including water-soluble sweeteners, water-soluble artificial sweeteners, water-soluble sweeteners derived from naturally occurring water-soluble sweeteners, dipeptide based sweeteners, and protein based sweeteners. Combinations comprising one or more sweeteners or one or more of the foregoing types of sweeteners can be used. Without being limited to particular sweeteners, representative categories and examples include:

water-soluble sweetening agents such as dihydrochalcones, monellin, steviosides, rebaudiosides, glycyrrhizin, dihydroflavenol, monatin, and L-aminodicarboxylic acid aminoalkenoic acid ester amides, such as those disclosed in U.S. Pat. No. 4,619,834, or a combination thereof;

water-soluble artificial sweeteners such as soluble saccharin salts, i.e., sodium or calcium saccharin salts, cyclamate salts, acesulfame salts, such as the sodium, ammonium or calcium salt of 3,4-dihydro-6-methyl-1,2,3-oxathiazine-4-one-2,2-dioxide, the potassium salt of 3,4-dihydro-6-methyl-1,2,3-oxathiazine-4-one-2,2-dioxide (Acesulfame-K), the free acid form of saccharin, or a combination thereof; dipeptide based sweeteners, for example the L-aspartic acid derived sweeteners such as L-aspartyl-L-phenylalanine methyl ester (Aspartame) and materials described in U.S. Pat. No. 3,492,131, L-alpha-aspartyl-N-(2,2,4,4-tetramethyl-3-thietanyl)-D-alaninamide hydrate (Alitame), methyl esters of L-aspartyl-L-phenylglycerine and L-aspartyl-L-2,5-dihydrophenyl-glycine, L-aspartyl-2,5-dihydro-L-phenylalanine; L-aspartyl-L-(1-cyclohexen)-alanine, neotame, or a combination thereof;

water-soluble sweeteners derived from naturally occurring water-soluble sweeteners, such as steviosides and stevia derived compounds such as but not limited to steviol glycosides such as rebaudiocides including rebaudiocide A, and the like, lo han quo and lo han quo derived compounds such as iso-mogroside V and the like, chlorinated derivatives of ordinary sugar (sucrose), e.g., chlorodeoxysugar derivatives such as derivatives of chlorodeoxysucrose or chlorodeoxygalactosucrose, known, for example, under the product designation of Sucralose; examples of chlorodeoxysucrose and chlorodeoxygalactosucrose derivatives include but are not limited to: 1-chloro-1′-deoxysucrose; 4-chloro-4-deoxy-alpha-D-galactopyranosyl-alpha-D-fructofuranoside, or 4-chloro-4-deoxygalactosucrose; 4-chloro-4-deoxy-alpha-D-galactopyranosyl-1-chloro-1-deoxy-beta-D-fructo-furanoside, or 4,1′-dichloro-4,1′-dideoxygalactosucrose; 1′,6′-dichloro1′,6′-dideoxysucrose; 4-chloro-4-deoxy-alpha-D-galactopyranosyl-1,6-dichloro-1,6-dideoxy-beta-D-fructofuranoside, or 4,1′,6′-trichloro-4,1′,6′-trideoxygalactosucrose; 4,6-dichloro-4,6-dideoxy-alpha-D-galactopyranosyl-6-chloro-6-deoxy-beta-D-fructofuranoside, or 4,6,6′-trichloro-4,6,6′-trideoxygalactosucrose; 6,1′,6′-trichloro-6,1′,6′-trideoxysucrose; 4,6-dichloro-4,6-dideoxy-alpha-D-galacto-pyranosyl-,6-dichloro-1,6-dideoxy-beta-D-fructofuranoside, or 4,6,1′,6′-tetrachloro4,6,1′,6′-tetradeoxygalacto-sucrose; 4,6,1′,6′-tetradeoxy-sucrose, or a combination thereof;

protein based sweeteners such as thaumaoccous danielli, talin, or a combination thereof; and

amino acid based sweeteners.

The chewy cooked candy may optionally further comprise a color. Coloring agents (colors, colorants, colorings) can be used in amounts effective to produce a desired color for the cooked candy and ultimately the chewing gum. Suitable coloring agents include pigments, which can be incorporated in amounts up to about 6 wt % based on the total weight of the chewing gum. For example, titanium dioxide can be incorporated in amounts up to about 2 wt %, and specifically less than about 1 wt % based on the total weight of the chewing gum. Suitable coloring agents also include natural food colors and dyes suitable for food, drug, and cosmetic applications. Suitable colors include annatto extract (E160b), bixin, norbixin, astaxanthin, dehydrated beets (beet powder), beetroot red/betanin (E162), ultramarine blue, canthaxanthin (E161g), cryptoxanthin (E161c), rubixanthin (E161d), violanxanthin (E161e), rhodoxanthin (E161f), caramel (E150(a-d)), β-apo-8′-carotenal (E160e), β-carotene (E160a), alpha carotene, gamma carotene, ethyl ester of beta-apo-8 carotenal (E160f), flavoxanthin (E161a), lutein (E161b), cochineal extract (E120), carmine (E132), carmoisine/azorubine (E122), sodium copper chlorophyllin (E141), chlorophyll (E140), toasted partially defatted cooked cottonseed flour, ferrous gluconate, ferrous lactate, grape color extract, grape skin extract (enocianina), anthocyanins (E163), haematococcus algae meal, synthetic iron oxide, iron oxides and hydroxides (E172), fruit juice, vegetable juice, dried algae meal, tagetes (Aztec marigold) meal and extract, carrot oil, corn endosperm oil, paprika, paprika oleoresin, phaffia yeast, riboflavin (E101), saffron, titanium dioxide, turmeric (E100), turmeric oleoresin, amaranth (E123), capsanthin/capsorbin (E160c), lycopene (E160d), FD&C blue #1, FD&C blue #2, FD&C green #3, FD&C red #3, FD&C red #40, FD&C yellow #5 and FD&C yellow #6, tartrazine (E102), quinoline yellow (E104), sunset yellow (E110), ponceau (E124), erythrosine (E127), patent blue V (E131), titanium dioxide (E171), aluminium (E173), silver (E174), gold (E175), pigment rubine/lithol rubine BK (E180), calcium carbonate (E170), carbon black (E153), black PN/brilliant black BN (E151), green S/acid brilliant green BS (E142), or a combination thereof. In an embodiment, certified colors can include FD&C aluminum lakes, or a combination thereof. A full recitation of all FD& C colorants and their corresponding chemical structures may be found in the Kirk-Othmer Encyclopedia of Chemical Technology, 4th Edition, in volume 1 at pages 492-494, which text is incorporated herein by reference.

Coloring agents can also include food grade glitter which can be incorporated into the cooked candy. The edible glitter can include a food grade colorant and a carrier such as a sugar, a sugar alcohol, a disaccharide, a polysaccharide, a hydrocolloid material, or a combination thereof. Exemplary glitter includes the commercially available Edible Glitter™ from Watson Inc. of West Haven, Conn.

The coloring agent can include food grade pearlescent pigments prepared from mica optionally coated with titanium dioxide, iron oxide, and the like.

In an embodiment, the chewy cooked candy comprises a fondant. The fondant can be made from a saccharide or a sugar polyol. The fondant can have crystalline particles of the saccharide or sugar polyol with an average particle size of less than 50 micrometers, specifically about 1 to about 30 micrometers, and more specifically about 10 to about 20 micrometers.

The fondant can generally be prepared by mixing a desired saccharide or sugar polyol with water. In an embodiment, the amount of water is used such that a slurry is prepared thus retaining some of the crystalline nature of the saccharide/polyol. In an embodiment, the saccharide and water or sugar polyol and water are heated, optionally to reduce the level of water, and then allowed to cool with mixing to result in saccharide/polyol crystal formation.

When used, the fondant can be present in the chewy cooked candy in an amount of about 0.01 to about 10 wt % of the cooked candy, specifically about 0.1 to about 7.0 wt %, more specifically about 1.0 to about 5.0 wt %, and still more specifically about 2.0 to about 3.0 wt %.

### Methods of Making the Chewy Cooked Candy

The chewy cooked candy is typically prepared by cooking a saccharide, a sugar alcohol, or a combination thereof, optionally mixed with added water, and optionally under vacuum to form a cooked composition. Ingredients, such as a particulate saccharide or particulate sugar alcohol, a flavorant, a fat, an emulsifier, a hydrocolloid, a fondant, etc. can be added to the cooked composition to form the chewy cooked candy. The fat is typically molten and combined with an emulsifier when used. The hydrocolloid can be pre-hydrated with water prior to use as an ingredient to prepare the chewy cooked candy.

In some embodiments, the chewy cooked candy is prepared using a batch method or a continuous method. As used herein, “a continuous mixer” is processing equipment in which the various ingredients used to prepare a composition are fed substantially continuously into the device whilst those ingredients are being mixed and removed or ejected from the mixing apparatus. For example, in a continuous mixing extruder, some ingredients are substantially continuously introduced through various feed ports while others are introduced downstream, all the while the screws, blades or other mixing elements continuing to convey the mixture through the apparatus, all the while mixing the same. At a downstream portion of the extruder, the wholly or partly combined mass is ejected from the extruder by the force of the mass continually being conveyed and/or facilitated by an external pump.

The chewy cooked candy can be prepared using a continuous process, a batch process, or a combination thereof. The cooked candy can be prepared using conventional equipment, such as fire cookers, vacuum cookers, or scraped-surface cookers (also referred to as high speed atmospheric cookers). The cooked candy can be prepared by a general process of preparing a cooked composition by applying heat to a mixture of a saccharide, a sugar alcohol, or a combination thereof and water to increase the solids content of the mixture by the removal of moisture.

In one embodiment, the final cook temperature used to prepare a chewy sugar-free cooked candy is about 124 to about 140° C., specifically about 126 to about 136° C., more specifically about 128 to about 134° C., and yet more specifically about 130 to about 132° C. Temperatures for a chewy non-sugar-free cooked candy can be about 115 to about 130° C. In comparison, hard boiled candies are typically prepared to a boiling temperature of greater than 150° C. for sugar-free based hard candies and 135 to 150° C. sugar-based hard candies. The chewy cooked candy can have a final moisture content of about 5 to about 15 wt %, specifically about 6 to about 12 wt %, and yet more specifically about 7 to about 10 wt % based on the total weight of the chewy cooked candy. In comparison, hard boiled candy can have a moisture content of 0.3 to 4 wt %.

Once the cooked material is prepared ingredients such as fats/oils, emulsifiers, hydrocolloids, colors, acids, flavors, and other ingredients can be mixed with the cooked material to form a cooked candy. In the foregoing method, the added ingredients can be mixed for a time effective to provide a uniform distribution of the materials.

In some embodiments, cooked material can be tempered on a cooling table and cooled to about 40 to about 55, specifically about 45 to about 55° C. prior to the addition of an ingredient such as a flavorant, a fondant, and the like. The resulting material can be further worked by aerating, pulling, kneading, etc. to achieve a desired consistency. In another embodiment, aeration can be done immediately after the cooking process using mechanical aeration techniques.

### Chewing Gum Product

In general the chewing gum product comprises a chewing gum composition comprising gum base and an optional bulk sweetener; and a chewy cooked candy as described above. When used, the bulk sweetener of the chewing gum composition, independent of the ingredients of the chewy cooked candy, can be a sugar-based or sugar-free bulk sweetener, specifically sugar-free.

The amount of chewy cooked candy present in the chewing gum product can be about 1 to about 65 wt % based on the total weight of the chewing gum product, specifically about 3 to about 50 wt %, more specifically about 5 to about 40, yet more specifically about 10 to about 30 wt %, and still yet more specifically about 15 to about 25 wt %. Other exemplary amounts include about 1 to about 15 wt % chewy cooked candy in the chewing gum product; or about 15 to about 65 wt % chewy cooked candy in the chewing gum product.

Bulk sugar sweeteners generally include saccharides. Suitable sugar sweeteners include mono-saccharides, di-saccharides and poly-saccharides such as but not limited to, sucrose (sugar), dextrose, maltose, dextrin, xylose, ribose, glucose, mannose, galactose, fructose (levulose), lactose, invert sugar, fructo oligo saccharide syrups, partially hydrolyzed starch, corn syrup solids, such as high fructose corn syrup, or a combination thereof.

In an embodiment, the bulk sweetener comprises a sugar alcohol. The sugar alcohol can be erythritol, galactitol, isomalt, a hydrogenated starch hydrolyzate, lactitol, maltitol, mannitol, polyglycitol, sorbitol, xylitol, and the like, or a combination thereof.

The amount of bulk sweetener, when present, in the chewing gum composition can be about 1 to about 85 wt % based on the total weight of the chewing gum product, specifically about 10 to about 75 wt %, more specifically about 15 to about 65 wt %, yet more specifically about 25 to about 55 wt %, and yet more specifically about 35 to about 45 wt % (the forgoing amounts are independent of any bulk sweetener used in the chewy cooked candy ingredient).

The chewing gum composition may further comprise an additional ingredient wherein the additional ingredient is a food acid or salt thereof, a high intensity sweetener, a sensate, a flavorant, a flavor modulator or potentiator, a coloring agent, a functional ingredient, a hydrocolloid, or a combination thereof. The foregoing additional ingredients are in addition to the food acid or salt thereof, high intensity sweetener, sensate, flavorant, flavor modulator or potentiator, coloring agent, and/or functional ingredient which may be present in the chewy cooked candy. In an embodiment, the additional ingredient is released from the chewing gum product later in the chew process than the flavorant, food acid or salt thereof, high intensity sweetener, sensate, or a combination thereof of the chewy cooked candy ingredient.

Exemplary additional food acid or salt thereof for use in the chewing gum composition can include those described above for use in the chewy cooked candy. The additional food acid or salt thereof may be used in free form or in an encapsulated form.

Exemplary additional high intensity sweetener for use in the chewing gum composition can include those described above for use in the cooked candy. Furthermore, the additional high intensity sweetener can be used in a variety of distinct physical forms, for example those known in the art to provide an initial burst of sweetness and/or a prolonged sensation of sweetness. Without being limited thereto, such physical forms include free forms (e.g., spray dried or powdered), beaded forms, encapsulated forms, or a combination thereof.

Exemplary additional sensate for use in the chewing gum composition can include those described above for use in the chewy cooked candy. The additional sensate may be used in free form or in an encapsulated form.

Exemplary additional flavorant for use in the chewing gum composition can be those described above for use in the chewy cooked candy. The flavorant can be used in liquid or solid form. When used in solid (dry) form, suitable drying means such as spray drying the oil can be used. Alternatively, the flavorant can be encapsulated, absorbed onto water soluble materials by means known in the art, for example cellulose, starch, sugar, maltodextrin, gum arabic, and the like. In an embodiment, the flavorant can be used in physical forms effective to provide an initial burst of flavor or a prolonged sensation of flavor.

Exemplary additional flavor modulator or potentiator, additional coloring agent, and additional functional ingredient for use in the chewing gum composition include those previously described above for use in the chewy cooked candy.

The amount of additional food acid or salt thereof, additional flavorant, additional sensate, additional coloring agent, additional flavor modulator or potentiator, additional functional agent, or a combination thereof present in the chewing gum composition can be up to about 5.0 wt % for each individual ingredient based on the total weight of the chewing gum product, specifically about 1.0 to about 4.0 wt %, and more specifically about 2.0 to about 3.0 wt %.

In an embodiment, the moisture content of the chewing gum product can be about 0.3 to about 10 wt % based on the total weight of the chewing gum, specifically about 0.5 to about 7.0 wt %, yet more specifically about 0.75 to about 4.0 wt %, and still yet more specifically about 1.0 to about 2.0 wt %. In an embodiment, the water activity of the chewing gum product can be about 0.1 to about 0.7, specifically about 0.2 to about 0.6, and more specifically, about 0.25 to about 0.5.

In an embodiment, the chewing gum product further comprises inclusions. The inclusions can be large particles of sugar alcohol, saccharide, or a confectionery such as a chewy candy, a crunchy candy, a low boiled candy, a hard boiled, a fondant, a caramel, a jelly, a gummy, a nougat, a fruit leather, a nut paste, chocolate, fudge, marshmallow, or a combination thereof. Generally, the inclusion can have an average particle size of about 0.35 to about 5 mm.

In an embodiment, a chewing gum product comprises a chewing gum composition comprising a gum base and a sugar alcohol bulk sweetener; and a chewy cooked candy; wherein the chewy cooked candy comprises a sugar alcohol, a flavorant, a fat, an emulsifier, and a hydrocolloid.

### Gum Base

The chewing gum composition comprises a chewing gum base. In an embodiment, the chewing gum composition comprises a gum base comprising an elastomer and optionally an additional gum base ingredient, wherein the additional gum base ingredient is a vinyl polymer, a fat, an emulsifier, an elastomer solvent, a plasticizer, a wax, a filler, an antioxidant, or a combination thereof.

As used herein, the term “gum base” refers to water insoluble material(s) and can include, but is not limited to, elastomers, bulking agents, waxes, elastomer solvents, emulsifiers, plasticizers, fillers, or a combination thereof.

The amount of gum base employed will vary greatly depending upon various factors such as the type of base used, the consistency of the chewing gum desired, piece weight, desired bolus size, and the other components used in the composition to make the final chewing gum. In general, the gum base will be present in amounts of about 5 to about 90 wt % based on the total weight of the chewing gum product, specifically about 15 to about 60 wt %, more specifically about 25 to about 50 wt %, and yet more specifically about 35 to about 40 wt %.

Exemplary elastomers to be used in the chewing gum base include both natural and synthetic elastomers and rubbers, for example, substances of vegetable origin such as chicle, crown gum, nispero, rosadinha, jelutong, perillo, niger gutta, tunu, balata, gutta-percha, lechi-capsi, sorva, gutta kay, and the like, or a combination thereof. Synthetic elastomers such as butadiene-styrene copolymers, polyisobutylene, isobutyleneisoprene copolymers, polyethylene, a combination thereof, and the like, or a combination thereof are also useful. The gum base can include a non-toxic vinyl polymer, such as polyvinyl acetate and its partial hydrolysate, polyvinyl alcohol, or a combination thereof. When utilized, the molecular weight of the vinyl polymer can range from about 3,000 up to and including about 94,000 or higher. Additional useful polymers include: crosslinked polyvinyl pyrrolidone, polymethylmethacrylate; copolymers of lactic acid, polyhydroxyalkanoates, plasticized ethylcellulose, polyvinyl acetatephthalate, or a combination thereof.

Conventional additives can be included in the gum base in effective amounts such as plasticizers or softeners to provide a variety of desirable textures and consistency properties. Because of the low molecular weight of these components, the plasticizers and softeners are able to penetrate the fundamental structure of the gum base making it plastic and less viscous. Suitable plasticizers and softeners include lanolin, palmitic acid, oleic acid, stearic acid, sodium stearate, potassium stearate, glyceryl triacetate, glyceryl lecithin, glyceryl monostearate, propylene glycol monostearate, acetylated monoglyceride, glycerin, or a combination thereof. Some of these ingredients may be added at the time of gum base formation or added later during the production of the chewing gum composition.

Waxes, for example, natural and synthetic waxes, hydrogenated vegetable oils, petroleum waxes such as polyurethane waxes, polyethylene waxes, paraffin waxes, microcrystalline waxes, fatty waxes, sorbitan monostearate, tallow, propylene glycol, and the like, or a combination thereof, can also be incorporated into the gum base to obtain a variety of desirable textures and consistency properties.

When a wax is present in the gum base, it softens the polymeric elastomer mixture and improves the elasticity of the gum base. The waxes employed may have a melting point below about 60° C., and specifically between about 45° C. and about 55° C. The low melting wax can be a paraffin wax. The wax can be present in the gum base in an amount of about 6 to about 10 wt %, and specifically about 7 to about 9.5 wt % based on the total weight of the gum base.

In addition to the low melting point waxes, waxes having a higher melting point can be used in the gum base in amounts up to about 5 wt % based on the total weight of the gum base. Such high melting waxes include beeswax, vegetable wax, candelilla wax, carnuba wax, most petroleum waxes, and the like, or a combination thereof.

The chewing gum composition or gum base can optionally contain conventional elastomer solvents to aid in softening the elastomer base component, for example trepanned resins such as polymers of alpha-pinene or beta-pinene; methyl, glycerol or pentaerythritol esters of rosins or modified rosins and gums, such as hydrogenated, dimerized or polymerized rosins, or a combination thereof; the pentaerythritol ester of partially hydrogenated wood or gum rosin; the pentaerythritol ester of wood or gum rosin; the glycerol ester of wood rosin; the glycerol ester of partially dimerized wood or gum rosin; the glycerol ester of polymerized wood or gum rosin; the glycerol ester of tall oil rosin; the glycerol ester of wood or gum rosin; the partially hydrogenated wood or gum rosin; the partially hydrogenated methyl ester of wood or rosin; and the like; or a combination thereof. The elastomer solvent can be used in amounts of about 5 to about 75 wt % base on the total weight of the gum base, and specifically about 45 to about 70 wt %.

The gum base can include effective amounts of bulking agents such as mineral adjuvants, which can serve as fillers and textural agents. Suitable mineral adjuvants include calcium carbonate, magnesium carbonate, alumina, aluminum hydroxide, aluminum silicate, talc, tricalcium phosphate, tricalcium phosphate and the like, or a combination thereof. These fillers or adjuvants can be used in the gum base in various amounts. Specifically the amount of filler, when used, can be present in an amount of greater than about 0 to about 60 wt % based on the total weight of the gum base, and more specifically from about 20 to about 30 wt %.

Suitable emulsifiers for use in the gum base include distilled monoglycerides, acetic acid esters of mono and diglycerides, citric acid esters of mono and diglycerides, lactic acid esters of mono and diglycerides, mono and diglycerides, polyglycerol esters of fatty acids, ceteareth-20, polyglycerol polyricinoleate, propylene glycol esters of fatty acids, polyglyceryl laurate, glyceryl cocoate, gum arabic, acacia gum, sorbitan monostearates, sorbitan tristearates, sorbitan monolaurate, sorbitan monooleate, sodium stearoyl lactylates, calcium stearoyl lactylates, diacetyl tartaric acid esters of mono- and diglycerides, glyceryl tricaprylate-caprate/medium chain triglycerides, glyceryl dioleate, glyceryl oleate, glyceryl lacto esters of fatty acids, glyceryl lacto palmitate, glyceryl stearate, glyceryl laurate, glycerly dilaurate, glyceryl monoricinoleate, triglyceryl monostearate, hexaglyceryl distearate, decaglyceryl monostearate, decaglyceryl dipalmitate, decaglyceryl monooleate, polyglyceryl 10 hexaoleate, medium chain triglycerides, caprylic/capric triglyceride, propylene glycol monostearate, polysorbate 20, polysorbate 40, polysorbate 60, polysorbate 80, polysorbate 65, hexylglyceryl distearate, triglyceryl monostearate, tweens, spans, stearoyl lactylates, calcium stearoyl-2-lactylate, sodium stearoyl-2-lactylate lecithin, ammonium phosphatide, sucrose esters of fatty acids, sucroglycerides, propane-1,2-diol esters of fatty acids, or a combination thereof.

### Methods of Making the Chewing Gum Product

The chewing gum product can be prepared using standard techniques and equipment. In an embodiment, the chewy cooked candy is added at the end of the chewing gum composition ingredients mixing process and mixed enough to form a homogeneous mass. However, the processes described herein are not necessarily limited to addition of the chewy cooked candy at the end of the mixing process as the final ingredient, rather it can be added at any desired stage of the chewing gum product manufacturing process.

In an embodiment, a method of making a chewing gum product comprises mixing gum base or a combination of gum base and a chewing gum ingredient to form an intermediate chewing gum composition; and mixing the intermediate chewing gum composition with a chewy cooked candy to form a chewing gum product, wherein the chewy cooked candy comprises i) a saccharide, a sugar alcohol, or a combination thereof, ii) a flavorant, and optionally iii) an emulsifier, a hydrocolloid, a fat, a fondant, a food acid or salt thereof, a high intensity sweetener, a sensate, or a combination thereof.

In an embodiment, the chewing gum product can contain a discrete phase of chewy cooked candy dispersed in a continuous chewing gum composition phase.

In an embodiment, the chewing gum product comprises microscopic regions of chewy cooked candy within the chewing gum composition matrix.

In one exemplary process, a gum base is heated to a temperature sufficiently high to soften the base without adversely affecting the physical and chemical make up of the base, which will vary depending upon the composition of the gum base used, and is readily determined by those skilled in the art without undue experimentation. For example, the gum base can be conventionally melted to about 60° C. to about 160° C., or melted to about 150° C. to about 175° C., for a period of time sufficient to render the base molten, e.g., about thirty minutes, just prior to being admixed incrementally with the remaining ingredients of the base such as the plasticizer, fillers, and softener to plasticize the blend as well as to modulate the hardness, viscoelasticity and formability of the base, the chewing gum ingredients are next blended with the gum base, with the chewy cooked candy being added at the end of the process. Mixing is continued until a uniform or homogeneous mixture of the chewing gum product is obtained. Thereafter the chewing gum product can be formed into a desired shape.

In another exemplary process, chewing gum ingredients are mixed with gum base, and the chewy cooked candy is added at the end of the chewing gum making process. Mixing is continued until a uniform or homogeneous mixture of the chewing gum product is obtained. Thereafter the chewing gum product can be formed into a desired shape. Within this embodiment, the starting gum base can be in an unmolten form, such as in the form of a pelletized gum base, that can be softened at 40 to 50° C. rather than melting at higher temperatures as in the prior embodiment.

The chewing gum composition and product can be prepared using a batch method or a continuous method or a combination thereof.

The processing equipment used to prepare the chewing gum composition and product can be monitored and/or controlled automatically. For example, the processing equipment can be coupled to a computerized system which allows the user to input certain and/or all of the operational parameters, including, e.g., feeding of the ingredients, mixing or processing the ingredients, conveying the ingredients. In an embodiment, the system can be coupled to batch processing equipment, continuous processing equipment, or both if both types are used. In an embodiment, changing the input parameters used to control the processing can create changes in the final composition, e.g., ingredient amount and type, etc. For example, the ingredient and/or processing temperatures and/or feed rates of the ingredients can be monitored and fed back to a central unit so that the operator can adjust as needed and/or in which the system can automatically adjust. After the ingredients have been mixed, the formation, processing into a particular shape and/or form can also be monitored and fed back for the operators input and/or automatic adjustment. An audible and/or visual alarm can also be implemented to signal the operator when the system detects a problem and/or a variation in one or more processing parameters.

The chewing gum product can be formed using a variety of processes including an extrusion process, a coextrusion process, a triple extrusion process, a laminate process, a molding process, a compression process, a rolling and scoring process, a chain die process, a rotary die process, or a cut and wrap process.

The chewing gum product can be shaped using devices and techniques that are known in the confectionery art. For example, the chewing gum product can be shaped by hand, with molds and/or dies, cutters, pullers, stretchers, extruders and the like. Non-limiting examples of molds that can be used include, flexible (e.g., made of silicone), metal, plastic, glass, and the packaging itself (e.g., by placing the unshaped mass into the pack), such as a blister pack Combinations of these may also be employed.

The chewing gum product can be prepared into discrete units in the form of slabs, sticks, pellets, balls, cubes, and the like. The formation into discrete units can be achieved using a chain die, or rolling and scoring process.

There is no limitation to the size of the discrete unit of the chewing gum product. In an embodiment, each discrete unit is about 1.5 to about 3.0 grams, specifically about 1.8 to about 2.7 grams, and more specifically about 2.3 to about 2.5 grams as a pellet, slab, or stick format.

The chewing gum can be packaged using techniques and equipment known in the art. For example gum stick packaging, packaging tins, blister trays, and the like can be used. In an embodiment is a packaged product that includes a chewing gum wherein the package has indicia on an outer surface that is indicative of the product contained in the package.

### Other Formats

In an embodiment, the chewing gum product is formulated into pieces and surface treated using materials and techniques known in the art. Exemplary surface treatments include panned coating (hard or soft), particulate coating (e.g., sanding, dusting, etc.), and treatment with oil optionally including a flavorant or other ingredient.

As used herein, “soft panned” coatings refer to coatings that provide a soft bite as measured by sensory testing methods. As used herein, “hard panned” coatings refer to coatings that provide a hard or crunchy or crispy bite as measured by sensory testing methods. The chewing gum products may be tested by a fully-trained descriptive analysis panel using various methods, for example, the analysis may be conducted using the Spectrum™ method. This method incorporates a trained panel of individuals who measure chewing gum products for several characteristics, providing a rating for each characteristic. The hardness of the coating may be measured on any scale desired. For example, hardness may be on a ten point scale from 1-10, where a rating of 1 is the softest and a rating of 10 is the hardest. Typically, soft panned coatings have a hardness rating below the rating of hard panned coatings. For example, in an embodiment, a soft panned coated product may have a hardness sensory rating of about 3-4, while hard panned coated product may have a hardness sensory rating of about 7-8.

The uncoated chewing gum pieces (alternatively described as “cores”) can be panned according to conventional processes to create a soft- or hard-panned layers. Conventional techniques for hard and soft panning technology are described in the following: “Sugarless Hard Panning”, Robert Boutin, et al., The Manufacturing Confectioner, pp. 35-42, November 2004; “Panning Technology, An Overview:”, John Flanyak, The Manufacturing Confectioner, pp. 65-74, January 1998; “Crystallization and Drying During Hard Panning”, Richard W, Hartel, The Manufacturing Confectioner, pp. 51-57, February, 1995; “Soft Panning”, Michael J. Lynch, The Manufacturing Confectioner, pp. 47-50, November 1987; and “Panning—The Specialist's Specialty”, Robert D. Walter, Candy & Snack Industry, pp. 43-51, December 1974. Each of these publications is incorporated herein by reference.

The coating composition at least partially surrounding the chewing gum core generally comprises a bulk sweetener and gum arabic, starch or a combination of gum arabic and starch. The coating composition optionally may further comprise an additional ingredient such as a color, a flavorant, a sensate, a food acid or salt thereof, a flavor modulator or potentiator, a functional ingredient, or a combination thereof. Each of these ingredients has been previously described herein. In an embodiment, the additional ingredient is encapsulated or unencapsulated (or “free”). If more than one ingredient is used, the coating may contain any combination of encapsulated or unencapsulated ingredients.

As used herein, the terms “coating” or “coating region” are used to refer to a region of a material that at least partially surrounds the chewing gum core.

As used herein, the terms “surround”, “surrounding”, “at least partially surrounding”, and the like are not limited to encircling. These terms may refer to enclosing or confining on all sides, encircling or enveloping, and are not limited to symmetrical or identical thicknesses.

As used herein, the term “substantially covers” and “substantially surrounding” refers to coating compositions that cover more than 50% of the surface area of a chewing gum core. In an embodiment, “substantially covers” may refer to coverage that is more than 55%, more than 60%, more than 65%, more than 70%, more than 75%, more than 80%, more than 85%, more than 90%, more than 95%, more than 98%, and more than 99% of the surface of a chewing gum core.

The particulate coating can include a powdered sugar, a particulate sugar alcohol, and the like. The particulate layer can be applied by any method known in the art including dusting where electrostatic forces adhere the particulate layer to the chewing gum core or sanding where a binder such as water or syrup helps to adhere the particulates to the chewing gum core.

The coating may be present in an amount from about 1 to about 60 wt %, specifically about 10 to about 45 wt %, and yet more specifically about 25 to about 30 wt % based on the total weight of the coated chewing gum.

The chewing gum product may further comprise a center-fill including liquid, semi-solid, solid (including powder), center-fill material. The center-filled chewing gum may be formed by any technique known in the art for forming center-filled confectionery. The method may generally include first extruding a center-filled rope of a chewing gum composition and passing the rope through a sizing mechanism including a series of pairs of pulley-shaped roller members. The roller members “size” the rope or strand of gum material such that it leaves the series of rollers with the desired size and shape for entering a piece-forming mechanism. The cooked candy is not a center-fill component of the chewing gum composition since it is blended with gum base as discussed above.

The chewing gum may be prepared in the form of a layered product comprising a layer or multiple layers of chewing gum product comprising the chewy cooked candy. In a multilayered product, at least one layer comprises a chewing gum product comprising a cooked candy while the remaining layers can be an additional chewing gum composition or a confectionery. The layered product can be in any format including a sandwich format with each layer visible on at least 2 sides, specifically at least 4 sides of the product, jelly roll format, and the like. The layered product can be prepared by a coextrusion process, a triple extrusion process, a laminate process, a molding process, a compression process, a rolling and scoring process, a chain die process, a rotary die process, or a cut and wrap process.

The chewing gum may further comprise printed indicia on the surface, either as abstract images (e.g., swirls, lines, dots, and the like), concrete images (e.g. flowers, animals, automobiles, and the like), letters, text, logos, characters, words, symbols, pictures, or a combination thereof, and the like, using colored inks. The printed indicia can be applied using either contact or non-contact techniques. Exemplary contact techniques include gravure printing. Exemplary non-contact techniques include ink-jet printing. In one embodiment, the chewing gum has printed indicia on two or more surfaces.

There is no limitation on the type of color used to prepare the printed indicia as long as it is food safe. More than one color can be used. Additionally, the color of the chewing gum product can be matched to the color of the printed indicia for a color on color effect. The color of the chewing gum product and the printed indicia can be selected to provide increased contrast. Vibrant colors can be selected for consumer appeal. The color of the printed indicia can also be matched with the flavor of the chewing gum product, for example a green printed image for a spearmint chewing gum, a blue printed image for a peppermint chewing gum, a red printed image for a red fruit flavored chewing gum, and the like. Additionally, the colorant composition can further comprise a flavorant.

The chewing gum comprising printed indicia on the surface can be a chewing gum product in the form of a sheet, discrete chewing gum piece, or a set of chewing gum pieces. The set of chewing gum pieces, when placed adjacent to one another, can comprise printed indicia that make up an overall image or pattern across the collection of pieces.

In an embodiment, the printed indicia comprises flavor, a sweetener, a food acid or salt thereof, a high intensity sweetener, a sensate, or a combination thereof.

### Sensory Evaluation of Chew Flavor

When the chewing gum product is chewed, the chewy cooked candy provides an initial burst of flavor at the early stage of the chew time. The flavor burst experienced by the consumer can be measured using sensory evaluation techniques. Sensory evaluation techniques are described in texts such as Sensory Evaluation of Food: Principles & Practices, by Harry T. Lawless and Hildegarde Heymann, the disclosure of which is herein incorporated by reference. Suitable sensory evaluation techniques include quantitative descriptive analysis (QDA). To conduct QDA testing, a panel of respondents may be assembled. Attribute terms for evaluation of samples are selected.

Normally, ballot development and respondent training is carried out initially. Descriptive terms are developed for major sensory attribute categories. Exemplary attribute qualities can include aroma, flavor, texture, aftertaste, sweetness, and the like or a combination thereof. Attributes are quantified with a linear intensity scale of from, e.g. 0 to 10; where 0 indicates that the attribute is not detected and 10 indicates the attribute is extremely strong. Overall quality rating may be measured with a linear scale of from, e.g. 1 to 10 where less than 6 is considered “poor,” 6 to 7 is “fair,” and 8 to 10 is “good.”

Physical reference standards are determined by a panel consensus so that proper descriptive language may be developed. Panelists may be trained in evaluating certain samples until a consensus is attained.

Overall quality ratings and quantified intensity ratings may be statistically analyzed with such programs as Minitab ver. 12 or SAS ver. 6.11. Descriptive statistical measures may be calculated for all attributes. Analysis of variance may be performed on each attribute using a randomized block design for balanced data with panelists as repeated measures as described by Ott, “Analysis of variance for some standard experimental designs,” pp. 844-856 in An Introduction to Statistical Methods and Data Analysis. Wadsworth Publishing. Belmont, Calif. Where F-test indicates a significant difference between treatment means, Tukey paired comparisons and orthogonal comparisons may be used to determine where the means are different. Significance of differences may be defined as P less than 0.05. Principal components analysis (PCA) may be applied with the factor analysis described by Lawless and Heymann, 1998, pp. 606-608 in Sensory Evaluation of Food: Principles and Practices. Chapman & Hall, New York, 1998. PCA may be applied to the attributes. Attributes may be omitted if the values are consistently low indicating that the attribute is not often present, if the attribute has a high standard deviation or if the attribute is highly correlated to another attribute. Kaiser's criterion may be applied (eigenvalue greater than 1) to determine the number of final factors from the initial ones as described by Massart et al., “Principal components and factor analysis,” pp. 339-369 in Chemometrics: A Textbook. Elsevier, Amsterdam, 1988. To facilitate the interpretation of results, the factors may be orthogonally rotated leading to uncorrelated factors following the Varimax method described by Massart et al., supra.

The chewing gum product exhibits an early flavor release when consumed. The early flavor release can be measured using sensory evaluation techniques such as those described above including quantitative descriptive analysis.

Various sensory properties include Initial Burst of Flavor (immediacy of flavor perception), Initial Sweetness, Soft Texture, Long Lasting Flavor, and Juicy Mouthwatering Flavor. The sensory attributes can be measured from the start of chew as well as at 0.5 1, 5, 15, and 30 minutes after the start of the chew.

In an embodiment, the flavorant in the chewy cooked candy provides an initial burst of flavor when the chewing gum product is consumed and an additional flavorant in the chewing gum composition that is not part of the chewy cooked candy is released from the chewing gum product for a duration of about 5 minutes or greater, specifically about 10 minutes or greater, and more specifically about 15 minutes or greater.

In an embodiment, the immediacy of flavor can be measured quantitatively using a mechanical chew extraction method and flavorant/sensate markers and the like that can be detected in the extraction solvent using a UV/Vis spectrophotometer. Exemplary markers include methyl salicylate (absorption at 237 nm), L-carvone (absorption at 241 nm), menthol, WS-3, WS-23, and the like. Chewing gum samples with known amounts of a flavor marker can be subjected to an in vitro mechanical chew test using equipment such as a Brabender Plasticorder (C.W. Brabender® Instruments, Inc.) drive unit equipped with a mixing head. The chewing gum sample is mixed within the equipment at a predetermined rotational speed as an extraction solvent is circulated at a set volume, rate, and temperature and for a select duration of time to extract the flavor marker from the sample. The resulting extraction solvent is tested with a UV/Vis spectrophotometer to measure the absorption at the wavelength of interest for the particular flavor marker. The sample absorptions are then used to calculate the concentration of flavor marker against data from a standard curve generated by measuring the absorption of solutions with known concentrations of flavor marker. The method allows for the determination of the rate and intensity of flavor release at set timeframes, e.g. early in a chew process or later.

A method of determining the amount of flavor release from a chewing gum, comprises preparing a chewing gum with a flavor marker, mixing the chewing gum in a mixing equipment equipped with circulating extraction solvent for a predetermined time, and measuring an absorption reading of the extraction solvent using a UV/Vis spectrophotometer set at a wavelength of the flavor marker. The method further comprises calculating the concentration of the flavor marker using the absorption reading.

In an embodiment, a chewing gum product comprises a chewing gum composition comprising gum base; and a chewy cooked candy wherein the chewing gum product releases more flavor than a comparative chewing gum having identical type and amount of ingredients wherein it does not comprise a chewy cooked candy. The flavor release can be measured using a mechanical chew out test at selected time points in the chew process, e.g. after 5 minutes of mechanical chewing, more specifically after 10 minutes, and yet more specifically after 15 minutes.

In one embodiment, a chewing gum product comprises a chewing gum comprising a gum base; and a chewy cooked candy comprising i) a cooked saccharide, a cooked sugar alcohol, or a combination thereof, ii) a flavorant, iii) an emulsifier, iv) a fat, v) a hydrocolloid, and optionally vi) a fondant, a food acid or salt thereof, a high intensity sweetener, a sensate, or a combination thereof; wherein the chewing gum composition and chewy cooked candy form a homogeneous mixture; and wherein when measured at a time period of up to 15 minutes of chewing, the chewing gum product releases more flavor than a comparative chewing gum having identical type and amount of ingredients, wherein the ingredients i)-vi) are not prepared as a candy or a pre-blend of ingredients prior to combining with the gum base. In a further embodiment is a chewing gum product wherein after 10 minutes of mechanical chewing, the chewing gum product releases about 5 to about 35% more flavor than a comparative chewing gum having identical type and amount of ingredients, wherein ingredients i)-vi) are not prepared as a candy or a pre-blend of ingredients prior to combining with the chewing gum composition. In another further embodiment is a chewing gum product wherein after 15 minutes of mechanical chewing, the chewing gum product releases about 5 to about 10% more flavor than a comparative chewing gum having identical type and amount of ingredients, wherein ingredients i)-vi) are not prepared as a candy or a pre-blend of ingredients prior to combining with the chewing gum composition. As used herein, “not prepared as a candy or a pre-blend of ingredients prior to combining with the chewing gum composition” means the ingredients are not made into a candy or a standalone composition prior to blending with the chewing gum composition.

In one embodiment, the chewing gum product comprises a chewing gum composition comprising a gum base and a bulk sweetener; and a chewy cooked candy comprising i) a sugar alcohol, ii) a fondant, iii) an emulsifier, iv) a flavorant, v) a fat, vi) a hydrocolloid, and optionally vii) a food acid or salt thereof, a high intensity sweetener, a sensate, or a combination thereof; wherein the chewy cooked candy is present in an amount of about 1 to about 65 wt % of the total chewing gum product; and wherein the chewy cooked candy is prepared separately from a mixture of the chewing gum composition, and then combined with the chewing gum composition to form the chewing gum product as a homogeneous mixture.

The features and advantages are more fully shown by the following examples which are provided for purposes of illustration, and are not to be construed as limiting the invention in any way.

### EXAMPLES

### Example 1

### Sugar-Free Chewing Gum with Chewy Cooked Candy Versus Comparative Example Without a Cooked Candy: Mechanical Chew Extraction Method for Rate and Intensity of Early Flavor Release

In this example, the flavor release of a sugar-free chewing gum comprising a chewy cooked candy (Ex. 1) is prepared from the ingredients listed in Table 1 below and compared to a comparative traditional chewing gum formulation of similar ingredients, but not containing a cooked candy (Comparative Example CE).

TABLE 1

| | Ex. 1 | CE |
|---|---|---|
| | % weight based on | |
| Ingredient | total wt chewing gum | |
| Gum base | 28.41 | 28.41 |
| Mannitol powder | — | 1.328 |
| Sugar alcohol syrup: | — | 8.9 |
| Maltitol syrup | | |
| Sugar alcohol powder: | | |
| Maltitol powder | 29.43 | 29.43 |
| Sorbitol powder | 24.86 | 24.86 |
| Gelatin 250 Bloom | — | 0.165 |
| Water | — | 0.897 |
| Lecithin 77% | 0.13 | 0.173 |
| Fat: | — | 0.488 |
| Hydrogenated coconut oil | | |
| Wintergreen | 1.47 | 1.96 |
| High intensity sweetener | 3.39 | 3.39 |
| Cooked candy | 12.3% | — |
| Sugar alcohol syrup: | 8.9 | — |
| Maltitol syrup | | |
| Sugar alcohol powder, (added to the | 1.2 | — |
| cooked sugar alcohol syrup): | | |
| Mannitol powder | | |
| Fat: | 0.488 | — |
| Hydrogenated coconut oil | | |
| Lecithin 77% | 0.043 | — |
| Wintergreen | 0.49 | — |
| Gelatin 250 Bloom | 0.165 | — |
| Water | 0.897 | — |
| Mannitol Fondant | 0.128 | — |
| Total chewing gum (wt %) | 100 | 100 |

### Preparation of Chewy Cooked Candy

The cooked candy is prepared by combining mannitol powder and maltitol syrup with water and cooking to a final temperature of about 135° C. in a kettle under vacuum to evaporate excess water. Molten fat, emulsifier, and hydrated gelatin are added once the temperature of the cooked mixture reaches below 100° C. and mixing continues for several minutes. The flavorant is then added to the mixture and blended. The resulting mixture is dropped to a cooling table and allowed to cool to about 45-50° C. Separately, the fondant is prepared by intensely mixing the fondant polyols with water. The fondant is then added to the cooled mixture and mixed to form a chewy cooked candy.

### Preparation of a Chewing Gum Composition

Ex. 1 is prepared by melting the gum base using techniques known in the art. The lecithin and bulk sweeteners are then added with mixing. The flavor is then added with mixing followed by the high intensity sweetener to form a chewing gum mixture. The chewing gum mixture is then mixed with the chewy cooked candy to form the chewing gum composition.

CE is prepared by melting the gum base using techniques known in the art. The lecithin, fat, maltitol syrup, and bulk sweeteners are then added with mixing. The hydrated gelatin and flavor is then added with mixing followed by the flavorant and high intensity sweetener to form a chewing gum mixture,

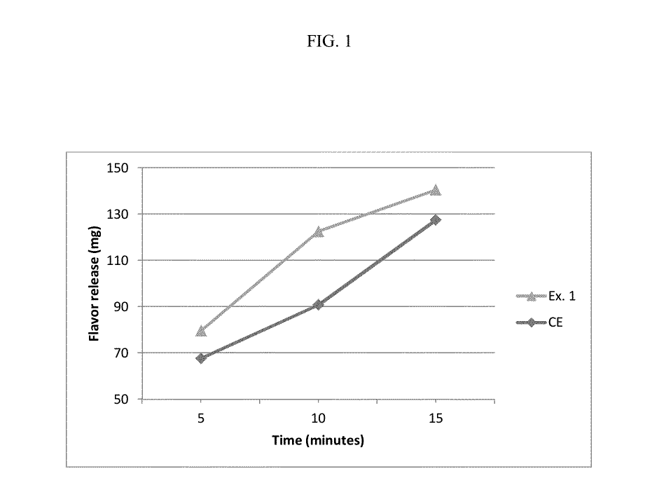

Ex. 1 and CE chewing gums were prepared with a single flavorant that contains a compound that can be detected quantitatively using a Visible/UV spectrophotometer. Wintergreen contains methyl salicylate having an absorption at 237 nm. Ex. 1 chewing gum contained 25% flavorant in the cooked candy and 75% added in the gum fraction, based on the total weight of the flavorant in the final formulation. Comparative Example CE contained 100% of the flavor in the gum fraction. The samples were analyzed using a mechanical chew extraction method to determine the rate and intensity of early flavor release. Flavorant was extracted from a 51 gram sample of chewing gum using a Brabender Plasticorder (C.W. Brabender® Instruments, Inc.) drive unit with a 35cc mixing head modified to increase the opening. The rotational speed was set at 80 rpm. Water at 21°-24° C. was circulated at a rate of 100 ml per minute. Two liters of water were used for each extraction that lasted for a preset amount of time (5, 10, and 15 minutes). A sample of the extraction water was used to measure the absorption at 237 nm wavelength with a Beckman DU 520 UV/Vis Spectrophotometer. The sample absorption was used to calculate the methyl salicylate concentration by using data from a standard curve. The standard curve was generated by measuring the absorption of solutions with known concentrations of methyl salicylate. The results of the study are provided in Table 2 below and the data is represented graphically in FIG. 1.

TABLE 2

| | | | Extraction time* | | |
|---|---|---|---|---|---|
| | | | 5 | 10 | 15 |
| | Cooked | Storage | minutes | minutes | minutes |
| Formulation | candy? | time | flavor released (mg) | | |
| CE | no | Time zero | 67.62 | 90.8 | 127.5 |
| Ex. 1 | yes | Time zero | 79.6 | 122.54 | 140.5 |

*each read under 5, 10 and 15 minutes is an average of multiple readings

The data shows the chewing gum of Ex. 1 prepared with the chewy cooked candy releases more flavorant during the early stage of chewing as compared to the chewing gum prepared without a cooked candy (CE). The chewing gum of Ex. 1 exhibited a quicker and higher flavor release property. It is noted that the shear provided during mechanical mastication is significantly lower than is provided by a human mouth. The surface of gum exposed to water in the mechanical masticator is significantly lower than a gum chewed by human and the sample mass is very large (51 g) compared to a typical chewing gum piece mass (about 2 g). Accordingly, 3 minutes of machine chew-out is about the same as about 1 minute of human chew-out. Thus it would be expected that the flavor release from the chewing gums would be significantly faster in vivo than exhibited in the mechanical chew-out.

As used herein the terms “comprising” (also “comprises,” etc.), “having,” and “including” is inclusive (open-ended) and does not exclude additional, unrecited elements or method steps. The singular forms “a,” “an,” and “the” include plural referents unless the context clearly dictates otherwise. The endpoints of all ranges directed to the same characteristic or component are independently combinable, and inclusive of the recited endpoint. The term “a combination thereof” is inclusive two or more components of the list and does not exclude other components not from the list unless noted otherwise. The term “homogeneous” refers to a uniform blend of the components. The term “or” means “and/or.” Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments.

While the invention has been described with reference to an exemplary embodiment, it will be understood by those skilled in the art that various changes can be made and equivalents can be substituted for elements thereof without departing from the scope of the invention. In addition, many modifications can be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A chewing gum product, comprising:
a chewing gum composition comprising a gum base; and
a chewy cooked candy comprising i) a cooked saccharide, a cooked sugar alcohol, or a combination thereof, ii) a flavorant, iii) an emulsifier, iv) a fat, v) a hydrocolloid, and optionally vi) a fondant, a food acid or salt thereof, a high intensity sweetener, a sensate, or a combination thereof;
wherein the chewy cooked candy comprises about 5 to about 15 wt % moisture based on the total weight of the chewy cooked candy;
wherein the chewing gum composition and chewy cooked candy form a homogeneous mixture; and
wherein when measured at a time period of up to 15 minutes of chewing, the chewing gum product releases more flavor than a comparative chewing gum having identical type and amount of ingredients, wherein the ingredients i)-vi) are not prepared as a candy or a pre-blend of ingredients prior to combining with the chewing gum composition.

2. The chewing gum product of claim 1, wherein after 10 minutes of mechanical chewing, the chewing gum product releases about 5 to about 35% more flavor than a comparative chewing gum having identical type and amount of ingredients, wherein ingredients i)-vi) are not prepared as a candy or a pre-blend of ingredients prior to combining with the chewing gum composition.

3. The chewing gum product of claim 2, wherein after 15 minutes of mechanical chewing, the chewing gum product releases about 5 to about 10% more flavor than a comparative chewing gum having identical type and amount of ingredients, wherein ingredients i)-vi) are not prepared as a candy or a pre-blend of ingredients prior to combining with the chewing gum composition.

4. The chewing gum product of claim 1, wherein the chewy cooked candy is prepared separately from the chewing gum composition, and then combined with the chewing gum composition to form the chewing gum product as a homogeneous mixture.

5. The chewing gum product of claim 1, wherein the sugar alcohol syrup is a non-crystallizing syrup.

6. The chewing gum product of claim 1, wherein the sugar alcohol syrup is a hydrogenated starch hydrolysate syrup, an isomaltulose syrup, a maltitol syrup, a sorbitol syrup, a polyglucitol syrup, or a combination thereof.

7. The chewing gum product of claim 1, wherein the saccharide syrup comprises sucrose, dextrose, maltose, dextrin, xylose, ribose, glucose, mannose, galactose, fructose (levulose), lactose, invert sugar, fructo oligo saccharide, partially hydrolyzed starch, high fructose corn syrup, polydextrose, or a combination thereof.

8. The chewing gum product of claim 1, wherein the cooked candy comprises the saccharide syrup or sugar alcohol syrup in an amount of about 30 to about 85 wt % based on the total weight of the cooked candy.

9. The chewing gum product of claim 1, wherein the chewy cooked candy further comprises a fondant.

10. The chewing gum product of claim 9, wherein the fondant comprises particulate erythritol, galactitol, a hydrogenated starch hydrolysate, isomalt, lactitol, maltitol, mannitol, polyglycitol, sorbitol, xylitol, or a combination thereof.

11. The chewing gum product of claim 9, wherein the fondant comprises particulate sucrose, dextrose, maltose, dextrin, xylose, ribose, glucose, mannose, galactose, fructose (levulose), lactose, fructo oligo saccharide, partially hydrolyzed starch, or a combination thereof.

12. The chewing gum product of claim 1, wherein the chewy cooked candy comprises a flavorant in an amount of about 0.01 to about 20 wt % based on the total weight of the chewy cooked candy.

13. The chewing gum product of claim 1, wherein the fat is a fat or oil comprising vegetable fat/oil, a hydrogenated vegetable fat/oil, a partially hydrogenated vegetable fat/oil, a dairy fat/oil, or a combination thereof.

14. The chewing gum product of claim 1, wherein the chewy cooked candy comprises a fat in an amount of about 1 to about 10 wt % based on the total weight of the chewy cooked candy.

15. The chewing gum product of claim 1, wherein the chewy cooked candy comprises an emulsifier in an amount of about 0.01 to about 15 wt % based on the total weight of the chewy cooked candy.

16. The chewing gum product of claim 1, wherein the chewy cooked candy further comprises a flavor modulator or potentiator, a coloring agent, a functional ingredient, a humectant, or a combination thereof.

17. The chewing gum product of claim 1, wherein the chewy cooked candy comprises a hydrocolloid in an amount of about of about 0.01 to about 10 wt % based on the total weight of the chewy cooked candy.

18. The chewing gum product of claim 1, wherein the chewing gum product comprises the chewy cooked candy in an amount of about 1 to about 65 wt % based on the total weight of the chewing gum product.

19. The chewing gum product of claim 1, wherein the chewing gum product comprises the chewy cooked candy in an amount of about 3 to about 50 wt % based on the total weight of the chewing gum product.

20. The chewing gum product of claim 1, wherein the chewing gum product comprises the chewy cooked candy in an amount of about 5 to about 40 wt % based on the total weight of the chewing gum product.

21. The chewing gum product of claim 1, wherein the chewing gum product comprises the chewy cooked candy in an amount of about 10 to about 30 wt % based on the total weight of the chewing gum product.

22. The chewing gum product of claim 1, wherein the chewing gum product comprises the chewy cooked candy in an amount of about 15 to about 25 wt % based on the total weight of the chewing gum product.

23. The chewing gum product of claim 1, wherein the chewing gum composition further comprises a bulk sweetener, wherein the bulk sweetener is a sugar polyol or a saccharide.

24. The chewing gum product of claim 23, wherein the bulk sweetener is present in an amount of about 1 to about 85 wt % based on the total weight of the chewing gum product.

25. The chewing gum product of claim 1, wherein the chewing gum product comprises the gum base in an amount of about 5 to about 95 wt % based on the total weight of the chewing gum product.

26. The chewing gum product of claim 1, wherein the chewing gum composition further comprises an additional ingredient, wherein the additional ingredient is a food acid or salt thereof, a high intensity sweetener, a sensate, a flavorant, a flavor modulator or potentiator, a coloring agent, a functional ingredient, a hydrocolloid, or a combination thereof.

27. (canceled)

28. The chewing gum product of claim 1, further comprising a coating, a center-fill, or a combination thereof.

29. (canceled)

30. The chewing gum product of claim 1, in the form of a layered product.

31. The chewing gum product of claim 1, in the form of a sheet, discrete chewing gum piece, or a set of chewing gum pieces, wherein each comprises printed indicia.

32. A method of making a chewing gum product, comprising:
mixing gum base or a combination of gum base and a chewing gum ingredient to form an intermediate chewing gum composition; and
mixing the intermediate chewing gum composition with a chewy cooked candy to form a chewing gum product,
wherein the chewy cooked candy comprises i) a saccharide, a sugar alcohol, or a combination thereof, ii) a flavorant, iii) an emulsifier, iv) a fat, v) a hydrocolloid, and optionally vi) a fondant, a food acid or salt thereof, a high intensity sweetener, a sensate, or a combination thereof.

33. (canceled)
